(19) United States
(12) Patent Application Publication
(10) Pub. No.: US 2003/0151669 A1
(43) Pub. Date: Aug. 14, 2003

(54) Image capturing device including remote enable/disable

(76) Inventors: Mark N. Robins, Greeley, CO (US); Heather N. Bean, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/073,764

(22) Filed: Feb. 11, 2002

(51) Int. Cl. H04N 5/225

(52) U.S. Cl. 348/207.99

(57) ABSTRACT

An image capturing device includes a memory, a communications device, and a processor. The processor receives an enable/disable communication from the communication device, interprets the enable/disable communication using a set of enable commands stored in the memory, and sets an enable state variable in the memory in response. The image capturing device is disabled for image capturing device operations when the enable state variable is set to a disable state and is enabled when the enable state variable is set to an enable state.

### FIELD OF THE INVENTION

The present invention relates generally to an image capturing device, and more particularly to an image capturing device including a remote enable/disable.

### BACKGROUND OF THE INVENTION

Still image capturing devices, such as cameras, are used to capture images, scenes, persons, events, etc. Image capturing devices are therefore popular for uses such as traveling, tours, vacations, etc. However, a common problem when traveling is having a camera available when needed or desired. When traveling, people often leave their camera at home because it could be stolen, because it is heavy and bulky and may be difficult to pack or carry, or because it may be difficult to obtain proper batteries, proper film, etc. Therefore, when traveling, a person may or may not be carrying a camera.

A prior art approach to the above problem is the availability of rental cameras. Rental cameras have typically been analog cameras that employ conventional film. A person may rent or use such a camera and may take home only the photographic film or photographic prints. The rental entity typically rents out an entire camera. The rental entity, therefore, has control over the rental camera by charging a deposit and may additionally lock the camera so that the renter cannot remove and/or replace the film.

Camera renters typically pay a flat usage fee or may have to purchase an entire roll of film. The rental entity therefore may have to replace a film roll during and/or after rental, and the user may end up with a partially consumed roll of film.

The rental camera approach of the prior art has several drawbacks. Payment for a film roll or payment for a period of use may deter renters. The renter may not want or need to use an entire roll of film, and may not want to pay for unused film. In addition, the pictures are generally not immediately available.

Another drawback is that the rental entity has no ability to enable or disable a particular camera. Moreover, the rental entity has no ability to enable or disable a group of cameras. Therefore, the rental entity has no control over camera use or camera availability. As a result, the rental entity has no control of the subject matter of pictures, which may cause problems in restrictive societies. This may also be desirable in other settings, such as in museums, concerts, etc., and even in research and development or manufacturing facilities.

Therefore, there remains a need in the art for improvements in image capturing devices.

### SUMMARY OF THE INVENTION

An image capturing device comprises a memory, a communications device, and a processor. The processor receives an enable/disable communication from the communication device, interprets the enable/disable communication using a set of enable commands stored in the memory, and sets an enable state variable in the memory in response. The image capturing device is disabled for image capturing device operations when the enable state variable is set to a disable state and is enabled when the enable state variable is set to an enable state.

### BRIEF DESCRIPTION OF THE DRAWINGS

FIG. 1 is a schematic of an image capturing device according to one embodiment of the invention;

FIG. 2 is a schematic of a removable memory medium according to another embodiment of the invention;

FIG. 3 is a flowchart of an image capturing method according to yet another embodiment of the invention; and

FIG. 4 is a flowchart of an image capturing method according to yet another embodiment of the invention.

### DETAILED DESCRIPTION

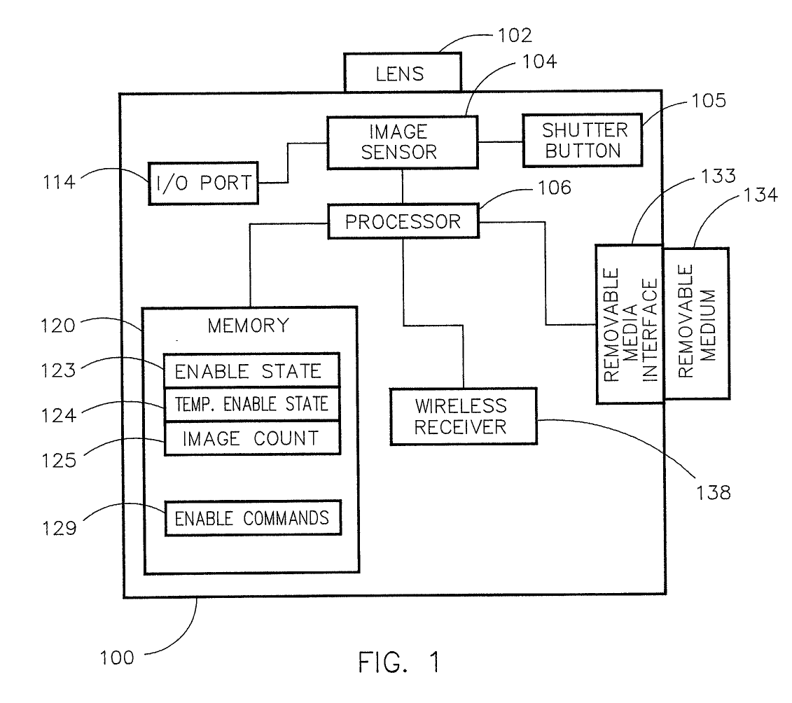

FIG. 1 is a schematic of an image capturing device 100 according to one embodiment of the invention. The image capturing device 100 includes a lens apparatus 102, an image sensor 104, a shutter button 105, a processor 106, and a memory 120. In addition, the image capturing device 100 may include an input/output (I/O) port 114, a removable media interface 133, and/or a wireless receiver 138.

The image sensor 104 may be any type of electronic image sensor capable of capturing images, such as a charge coupled device (CCD) sensor or a complementary metal oxide semiconductor (CMOS) sensor, for example. Alternatively, the image sensor 104 may be any type of conventional photographic film.

The processor 106 may be any type of general purpose processor. The processor 106 executes a control routine contained in the memory 120. In addition, the processor 106 receives inputs and conducts image capturing operations.

The removable media interface 133 may receive any manner of removable medium 134. If the image capturing device 100 is a digital camera, the removable medium 134 may be a memory card or disk, for example. The memory card or disk may include an enabling code. Alternatively, the removable medium 134 may be a dongle, wherein the dongle may include circuitry that enables the image capturing device 100 when the dongle is plugged into the removable media interface 133. Alternatively, the removable medium 134 may be a key inserted at a rental desk.

In one embodiment, the removable medium 134 may be inserted into an image capturing device 100 to enable the image capturing device 100. Therefore, without the proper removable medium 134, the image capturing device 100 may be inoperative.

In another embodiment, the image capturing device 100 may be enabled by the wireless receiver 138. The wireless receiver 138 may be capable of receiving wireless communications. This may include receiving enable/disable communications for the image capturing device 100, such as enable/disable communications from a rental or control entity. In addition, the wireless receiver 138 may receive commands from a fixed wireless transmitter that disables the image capturing device 100 in relation to a fixed subject or setting. As a result, such a fixed wireless transmitter may temporarily disable all image capturing devices within range. In this manner, the fixed wireless transmitter may be placed in areas where pictures are not allowed to be taken, and the image capturing device 100 according to the invention may be safely used in restrictive societies.

The I/O port 114 may be used to receive an enable/disable communication. In addition, it may be used to download images and/or to check the number of captured images in the image capturing device 100. The I/O port 114 may be any type of wire type communication port. For example, the I/O port 114 may be a USB port, wherein a USB cable may connect the image capturing device to a computer or other electronic device.

The memory 120 may be any type of digital memory. The memory 120 may store, among other things, an enable state variable 123, a temporary enable state variable 124, an image count 125, and a set of enable commands 129. In addition, the memory 120 may store captured images and may store software or firmware to be executed by the processor 106.

The enable state variable 123 is a variable that may be used to enable or disable the image capturing device 100. The enable state variable 123 is preferably only settable by a rental or control entity. The enable state variable 123 may be set through an enable/disable communication received from the I/O port 114, from the wireless receiver 138, or from the removable medium 134.

The temporary enable state variable 124 is a variable that overrides the enable state variable 123 when the image capturing device 100 is within range of a fixed wireless transmitter. Therefore, if the temporary enable state variable 124 is set to a disable state, the image capturing device 100 is disabled even if the enable state variable 123 is set to an enable state. In the absence of a disable communication, the temporary enable state variable 124 may revert to an enable state.

The image count 125 records the number of images stored in the memory 120. The image count 125 therefore records the number of pictures captured by a renter or user, and may be used for billing purposes. The image count 125 may be read through the I/O port 114, the wireless receiver 138, or may be stored onto the removable medium 134 and may be removed and read by the rental agency. In addition, the image count 125 may be read out through some manner of camera display or user interface, such as a camera-back LCD screen, for example.

The set of enable commands 129 may comprise one or more stored commands that are used by the processor 106 to decode the enable/disable communications. The set of enable commands 129 therefore enable a rental or control entity to control the enable state variable 123.

In operation, if the enable state variable 123 is set to enable, a user may capture images to the memory 120 and perform any other image capturing device operations. The image capturing device 100 may be used until either disabled by the rental or control entity or disabled by a fixed wireless transmitter.

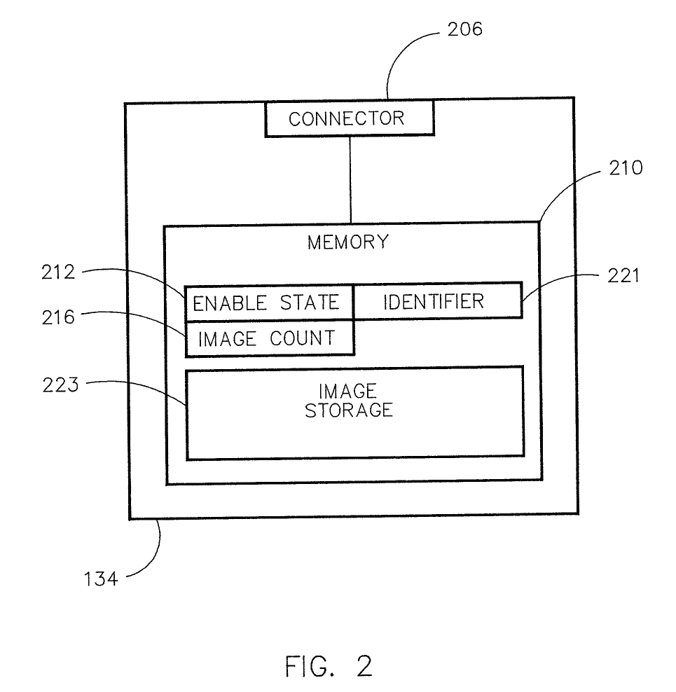

FIG. 2 is a schematic of a removable memory medium 134 according to another embodiment of the invention. In one embodiment, the removable memory medium 134 may be any manner of memory card or memory disk that includes a memory 210. The memory 210 may include, for example, an enable state variable 212, an image count 216, an identifier 221, and an image storage 223.

If the removable memory medium 134 is a memory card, it may include a connector 206. The connector 206 mates with a corresponding connector in the removable media interface 133.

The enable state variable 212 may be similar to the enable state variable 123 of the memory 120 in the image capturing device 100. The enable state variable 212 may be programmed by the rental or control entity to enable/disable the image capturing device 100. Therefore, the enable state variable 212 on the memory card 134 may be read into the enable state variable 123 of the memory 120.

The image count 216 may be a count of images stored in the image storage 223. Alternatively, the image count 216 may include both images stored in the image storage 223 and images stored in the memory 120. The image count 216 may be read out into the image count 125 of the memory 120 of the image capturing device 100.

The identifier 221 may be a serial number or other identifier that is used by the rental entity to track image capturing devices. In addition, the identifier 221 may be used to control a particular image capturing device. For example, in one embodiment the removable memory medium does not enable the image capturing device 100 unless the image capturing device identifier 221 corresponds to the image capturing device 100.

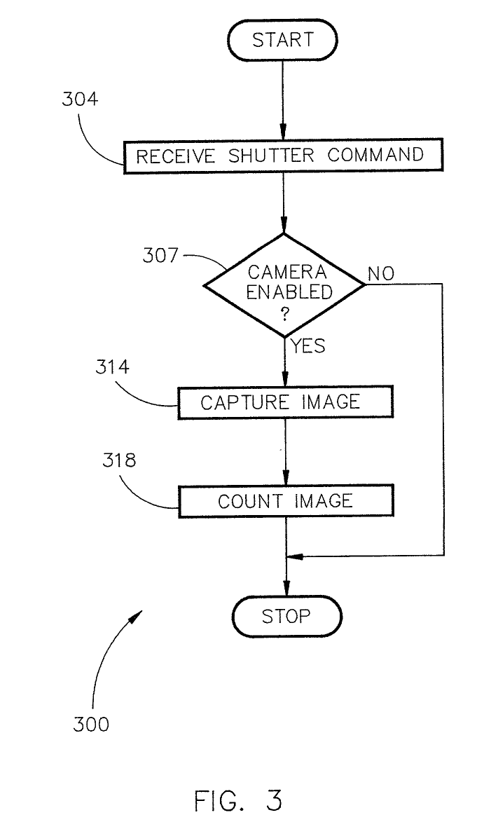

FIG. 3 is a flowchart 300 of an image capturing method according to yet another embodiment of the invention. In step 304, a shutter command is received by the image capturing device 100 in response to a press of the shutter button 105 by the user.

In step 307, the method determines whether the image capturing device 100 is enabled. This may be done by checking the enable state variable 123 in the memory 120. If the enable state variable 123 is set to an enabled state, the method proceeds to step 314; otherwise it exits.

In step 314, image capturing device operations are allowed. For example, an image capture may be allowed and therefore an image may be captured and stored. The image may be stored to the memory 120 or may be stored to the removable medium 134, such as a memory card or disk. In addition, other image capturing device operations may be enabled or disabled, including all image capturing device operations (i.e., in one embodiment the image capturing device 100 may be essentially dead when disabled).

In step 318, the captured image may be counted in the image count variable 125 or in the image count variable 216.

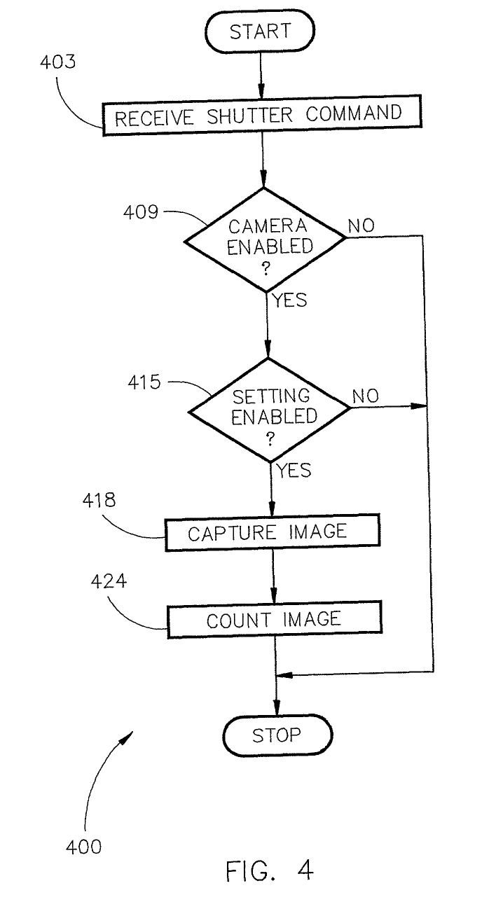

FIG. 4 is a flowchart 400 of an image capturing method according to yet another embodiment of the invention. In step 403, a shutter command is received, as previously discussed.

In step 409, it is determined whether the image capturing device 100 is enabled, as previously described. If it is enabled, the method proceeds to step 415; otherwise the method exits.

In step 415, the method determines whether the particular image capture setting is enabled, i.e., whether the approximate image the user is attempting to capture is allowed. If the particular image capture setting is enabled, the method proceeds to step 418; otherwise the method exits.

The check for whether the particular image capture setting is allowed is done by checking the temporary enable state variable 124. If the temporary enable state variable 124 is set to a disabled state, then the image capturing device 100 is disabled (even if the enable state variable 123 is set to an enabled state). The particular image capture setting therefore may be allowed unless a disable communication is received from the wireless receiver 138 (i.e., from the fixed wireless transmitter). Consequently, even when enabled by the rental or control entity, the image capturing device 100 may be temporarily disabled by a signal received from a fixed wireless transmitter located at a restricted site. This temporary disabling only exists as long as the image capturing device 100 is within range of the fixed wireless transmitter. When the image capturing device 100 is transported away from the fixed wireless transmitter, the previous enable or disable state takes effect. Therefore, if the image capturing device 100 had been enabled, it will again be enabled.

In step 418, an image is captured, as previously discussed.

In step 424, the captured image is counted, as previously discussed.

The remote enable/disable according to the invention may apply to any type of image capturing device, such as digital or film cameras. The invention especially applies to rental image capturing devices. Moreover, the invention applies to rental image capturing devices for tour groups or groups wherein control over picturing taking is desired. Moreover, it applies to tour groups or groups where desirable rental image capturing devices are needed.

The remote enable/disable capability of the invention differs from the prior art in that the rental or control entity is capable of enabling and disabling a specific image capturing device. Moreover, the rental or control entity is capable of performing a group enable and disable of image capturing devices. Furthermore, the invention provides the ability to disable all image capturing devices at a specific setting or location.

The remote enable/disable according to the invention provides several benefits. The remote enable/disable may allow the use and rental of a digital image capturing device. It provides a rental device available not only on a flat fee basis, but may also be provided on a per-picture or per-print basis. In a per-print plan, captured images are printed on location so the user has only to bring home photographs and does not need to provide his or her own memory card or memory medium. This approach also allows scrutiny of prints by humans to eliminate any concern over restricted photos in controlled societies.

In a digital image capturing device embodiment, the user can rent an image capturing device and take a large number of pictures without concern of how many the user can take. The renter can optionally bring his or her own memory medium and just rent the digital image capturing device. In the digital device embodiment, there is no need for the user to return to the rental entity when a roll of film is used up. Moreover, pictures can be downloaded and electronically transmitted to one or more destinations.

The invention allows control over cameras in situations where individual tourists or persons cannot be educated on local customs, or in situations where individual tours or persons cannot be controlled. The invention further allows control over picture taking in settings where picture taking would be disruptive, where secrecy concerns are present, etc.

We claim:

1. An image capturing device, comprising:
a memory storing an enable state variable and a set of enable commands;
a communications device capable of receiving an enable command and a disable command; and
a processor communicating with said memory and with said communications device, with said processor receiving an enable/disable communication from said communication device, interpreting said enable/disable communication using said set of enable commands, and setting said enable state variable in response;
wherein said image capturing device is disabled for image capturing device operations when said enable state variable is set to a disable state and is enabled when said enable state variable is set to an enable state.

2. The device of claim 1, wherein said communications device comprises an input/output (I/O) port capable of communicating with an external device.

3. The device of claim 1, wherein said communications device comprises a wireless receiver capable of communicating with an external device.

4. The device of claim 1, wherein said communications device comprises a removable media interface and a removable medium plugged into said removable media interface.

5. The device of claim 4, wherein said removable medium further comprises a removable memory medium.

6. The device of claim 4, wherein said removable medium further comprises a removable memory medium and wherein said removable memory medium comprises:
a connector for electrically connecting to said removable media interface; and
a memory communicating with said connector and storing an enable state variable;
wherein said enable state variable is loaded into said image capturing device and enables or disables said image capturing device.

7. The device of claim 6, with said memory further storing an image capturing device identifier, wherein said removable memory medium does not enable said image capturing device unless said image capturing device identifier corresponds to said image capturing device.

8. The device of claim 4, wherein said removable medium further comprises a dongle, with said dongle including circuitry that enables said image capturing device.

9. The device of claim 1, further comprising a temporary enable state variable that overrides said enable state variable when said temporary enable state variable is set to a disable state.

10. An image capturing method for an image capturing device, comprising the steps of:
receiving a shutter command;
checking an enable state variable to see if said image capturing device is enabled; and
performing image capturing device operations if said enable state variable is set to an enable state.

11. The method of claim 10, further comprising the steps of:
receiving an enable/disable command in a communication device of said image capturing device; and
toggling said enable state variable in response.

12. The method of claim 11, wherein said enable/disable command is received from an input/output (I/O) port on said image capturing device.

13. The method of claim 11, wherein said enable/disable command is received from a wireless receiver in said image capturing device.

14. The method of claim 11, wherein said enable/disable command is received from a removable medium plugged into a removable media interface of said image capturing device.

15. The method of claim 10, wherein said enable/disable command is received from a rental entity.

16. The method of claim 10, wherein said enable/disable command is received from a fixed wireless transmitter that temporarily disables said image capturing device when said image capturing device is in range of said fixed wireless transmitter.

17. The method of claim 10, further comprising the step of checking a temporary enable state variable to see if said image capturing device is temporarily disabled, wherein image capturing operations are performed if said enable state variable is set to an enable state and if said temporary enable state variable is set to an enable state

18. An image capturing method for an image capturing device, comprising the steps of:
receiving a shutter command;
checking an enable state variable to see if said image capturing device is enabled;
checking a temporary enable state variable to see if said image capturing device is temporarily disabled; and
performing image capturing device operations if said enable state variable is set to an enable state and if said temporary enable state variable is set to an enable state.

19. The method of claim 18, further comprising the steps of:
receiving an enable/disable command in a communication device of said image capturing device; and
toggling said enable state variable in response.

20. The method of claim 19, wherein said enable/disable command is received from an input/output (I/O) port on said image capturing device.

21. The method of claim 19, wherein said enable/disable command is received from a wireless receiver in said image capturing device.

22. The method of claim 19, wherein said enable/disable command is received from a removable medium plugged into a removable media interface of said image capturing device.

23. The method of claim 18, wherein said enable/disable command is received from a rental entity.

24. The method of claim 18, wherein said enable/disable command is received from a fixed wireless transmitter that temporarily disables said image capturing device when said image capturing device is in range of said fixed wireless transmitter.
